(19) United States
(12) Patent Application Publication
(10) Pub. No.: US 2014/0326598 A1
(43) Pub. Date: Nov. 6, 2014

(54) MODULE-TYPE BIOSENSOR

(71) Applicant: Ceragem Medisys, Inc., Chungcheongnam-do (KR)

(72) Inventors: Jin-Woo Lee, Gyeonggi-do (KR); Jae-Kyu Choi, Chungcheongnam-do (KR)

(21) Appl. No.: 14/345,871

(22) PCT Filed: Sep. 20, 2012
(86) PCT No.: PCT/KR2012/007518

§ 371 Date: Mar. 19, 2014

(30) Foreign Application Priority Data
Sep. 20, 2011 (KR) 10-2011-0094423

(51) Int. Cl. G01N 27/30

(52) U.S. Cl. CPC G01N 27/30
USPC 204/403.01

(57) ABSTRACT

Provided is a module type biosensor which is easily coupled with and separated from a detector. The module type biosensor includes a reaction substrate which reacts with an introduced sample and generates a reaction signal, a first structure body which is formed as a pole-shaped figure having an opening formed at one base side thereof and in which a detector performing an analysis of the introduced sample based on the reaction signal generated from the reaction substrate is inserted and coupled into an opened base side having the opening so as to be in contact with the reaction substrate, and the reaction substrate is coupled to a blocked base side of a position corresponding to an opened base side, a second structure body which is coupled to the blocked base side and forms a reaction chamber generating the reaction signal when being coupled to the blocked base side, and a housing which is formed to enclose outer surfaces of the first structure body and the second structure body and slides along the outer surfaces of the first structure body and the second structure body.

### TECHNICAL FIELD

The present invention relates to a module type biosensor, and more particularly, to a module type biosensor which may easily couple and separate a biosensor and a detector.

### BACKGROUND ART

A biosensor is referred to as a measurement device which may inspect properties or the like of a substance using a function of a living body. Since the biosensor uses a biological material as a detecting device, it has excellent sensitivity and reaction specificity. Due to such advantages, the biosensor is widely used in the fields of medicine and pharmacy, such as clinical chemistry analysis, process instrumentation in bio-industry, environment measurement and safety evaluation of a chemical substance, and the range of use thereof is being increased continuously. Particularly, the biosensor is frequently used in the field of medicine diagnosis in order to analyze biological samples including a specimen. The biosensor may be classified into a biosensor used in an enzymatic analysis and a biosensor used in an immunoassay according to a kind of the detecting device, and may be also classified into an optical biosensor and an electrochemical biosensor according to a quantitative analysis method of a target substance.

The biosensor used in the enzymatic analysis uses a specific response between an enzyme and a substrate and between an enzyme and an inhibitor of enzyme reaction, and the biosensor used in the immunoassay uses a specific response between an antigen and an antibody.

The optical biosensor is a method which measures light transmittance, an optical density or a change in wavelength and thus measures a concentration of a target material and which is the most commonly used. The method using the optical biosensor has some advantages in that reaction mechanisms of various materials are already well known and it has a small deviation with respect to measurement time, because a measurement operation is performed after a reaction is achieved for a sufficient time. However, in the optical biosensor, a measured result is affected by turbidity of a sample, and it is difficult to miniaturize an optical part, and also a longer measurement time and a larger amount of samples are required, compared with the electrochemical biosensor.

The electrochemical biosensor is a method which measures an electric signal obtained from a biochemical reaction and thus measures the concentration of the target material. The electrochemical biosensor may amplify a signal with only a thimbleful of the sample, may be easily miniaturized, may stably obtain a measurement signal, and may be also easily conflated with information communicative machines.

Meanwhile, a conventional biosensor which generally has a flat strip structure has a thin stick shape including a plurality of thin layers such as a lower substrate, a reaction substrate, a spacer and an upper substrate, and thus has a very small size, compared with its complicated structure. However, main users of the biosensor are diabetic patients or the elderly who cannot see well or have hand tremor, and thus they may not easily insert the small-sized biosensor into a narrow slit of a detector.

Further, the strip type biosensor is exposed to the outside when being inserted into the detector by the user, and thus may be easily contaminated.

Further, when the strip type biosensor is removed from the detector after measurement of a blood sugar level, the user pulls a portion containing blood with a hand. At this time, since the user's hand may be stained with the blood, it is very inconvenient and unsanitary.

### DISCLOSURE

### [Technical Problem]

The present invention is directed to providing a module type biosensor which is easily coupled with or separated from a detector.

The present invention is also directed to providing a module type biosensor which prevents contamination due to outside exposure.

The present invention is also directed to providing a module type biosensor which improves convenience for use and sanitation.

### [Technical Solution]

One aspect of the present invention provides a module type biosensor including a reaction substrate which reacts with an introduced sample and generates a reaction signal, a first structure body which is formed as a pole-shaped figure having an opening formed at one base side thereof and in which a detector performing an analysis of the introduced sample based on the reaction signal generated from the reaction substrate is inserted and coupled into an opened base side having the opening so as to be in contact with the reaction substrate, and the reaction substrate is coupled to a blocked base side of a position corresponding to an opened base side, a second structure body which is coupled to the blocked base side and forms a reaction chamber generating the reaction signal when being coupled to the blocked base side, and a housing which is formed to enclose outer surfaces of the first structure body and the second structure body and slides along the outer surfaces of the first structure body and the second structure body.

The module type biosensor may further include a first cover which is attached to one end of the housing and protects the reaction substrate exposed to an outside through the second structure body; and a second cover which is attached to the other end of the housing and protects the reaction substrate exposed to the outside through the first structure body.

Another aspect of the present invention provides a module type biosensor including a reaction substrate which reacts with an introduced sample and generates a reaction signal, and a structure body in which an opening is formed at a hollow-shaped first base side thereof, a second base side has a cap shape, and the reaction substrate is coupled to an inner surface of the second base side, and a housing which is formed to enclose an outer surface of the structure body and slides along the outer surface of the structure body.

The structure body may include a coupling groove to which the reaction substrate is coupled, an introduction port through which a sample is introduced to the reaction substrate coupled to the coupling groove, and a capillary groove which quickly transports the sample introduced through the introduction port to the reaction substrate.

Still another aspect of the present invention provides a module type biosensor including a reaction substrate which reacts with an introduced sample and generates a reaction signal, a first structure body which has a hollow shape and in which a first outer diameter portion and a second outer diameter portion having a larger width than the first outer diameter portion are formed at an outer surface of the hollow shape to be adjacent to each other up and down, and a stepped surface is formed at a boundary portion between the first outer diameter portion and the second outer diameter portion, and a blocked base side is formed to extend toward an inner side of an end of the first outer diameter portion, and a coupling groove to which the reaction substrate is coupled is formed at an inner surface of the first outer diameter portion, and an introduction port through which a sample is introduced to the reaction substrate coupled to the coupling groove is formed at the blocked base side, and a capillary groove which quickly transports the sample introduced through the introduction port to the reaction substrate is formed at the coupling groove, and a housing which is formed to enclose the main structure body and slides along an outer surface of the main structure body.

The first structure body may include a second structure body which has the coupling groove and is coupled with the reaction substrate; and a third structure body which is coupled with the second structure body while the reaction substrate is interposed therebetween and forms the first structure body.

### [Advantageous Effects]

According to the present invention, when the detector is coupled to the lower structure body or the main structure body to which the reaction substrate is coupled, the reaction substrate and the detector are in contact with each other, and thus the detector may be easily in contact with the reaction substrate. That is, in the conventional biosensor, the reaction substrate having a relatively small size was direction inserted into the detector so that the reaction substrate and the detector were in contact with each other. However, according to the present invention, since the reaction substrate is coupled to the lower structure body or the main structure body having the relatively large size, and the detector is coupled to the lower structure body or the main structure body to which the reaction substrate is coupled so that the reaction substrate and the detector are in contact with each other, the reaction substrate and the detector may be further easily in contact with each other, compared with the conventional biosensor.

Also, the reaction substrate is located at the inside of the lower structure body, the upper structure body, the housing, the lower cover and the upper cover, or located at the inside of the main structure body, the housing, the lower cover and the upper cover. When using the module type biosensor, the lower cover is first removed, and the detector is coupled to the lower structure body or the main structure body located at a position from which the lower cover is removed, and thus the reaction substrate is not exposed to the outside, and it is possible to prevent the contamination due to the exposure to the outside.

Furthermore, when the reaction substrate is separated from the detector, the reaction substrate may be easily separated from the detector by grasping the lower structure body or the main structure body, to which the reaction substrate is coupled, with a hand and removing the lower structure body. Therefore, convenience and sanitation are enhanced, compared with the conventional case in which a user pulls a portion containing blood with a hand.

### DESCRIPTION OF DRAWINGS

FIG. 1 is a perspective view of a module type biosensor according to one exemplary embodiment of the present invention.

FIG. 2 is an exploded perspective view of FIG. 1.

FIGS. 3A and 3B are plan views of a reaction substrate of FIG. 1.

FIG. 4 is a perspective view of a lower structure body of FIG. 1.

FIG. 5 is a perspective view of an upper structure body of FIG. 1.

FIGS. 6A to 6F are cross-sectional views illustrating various coupling states of the reaction substrate in the module type biosensor of FIG. 1.

FIG. 7 is a perspective view of a housing of FIG. 1.

FIG. 8 is a perspective view illustrating a coupled structure of the reaction substrate, the lower structure body and the upper structure body of FIG. 1.

FIG. 9 is a perspective view illustrating an internal structure of the lower structure body of FIG. 1

FIGS. 10A and 10B are cross-sectional views illustrating operation states of FIG. 1.

FIG. 11 is an exploded perspective view of a module type biosensor according to another exemplary embodiment of the present invention.

FIG. 12 is a perspective view illustrating an external structure of a main structure body of FIG. 11.

FIG. 13 is a perspective view illustrating an internal structure of the main structure body of FIG. 11.

FIGS. 14A and 14B are perspective views illustrating operation states of FIG. 11.

FIG. 15 is an exploded perspective view of a module type biosensor according to still another exemplary embodiment of the present invention.

FIG. 16 is a perspective view illustrating an external structure of a main structure body of FIG. 15.

FIG. 17 is a perspective view illustrating an internal structure of the main structure body of FIG. 15.

FIG. 18 is a perspective view of a first structure body and a second structure body of FIG. 14.

FIGS. 19A and 19B are perspective views illustrating operation states of FIG. 14.

FIG. 20 is a schematic view illustrating a coupling state between the module type biosensor and a detector.

### MODES OF THE INVENTION

Although the present invention may be modified in many different forms and may have various exemplary embodiments, only particular exemplary embodiments are illustrated in the drawings and will be described fully.

However, the present invention is not limited to the embodiments, and it should be understood that the present invention comprises all of equivalents and substitutes included in the technical scope and spirit of the invention.

The terms used herein are merely to describe a specific embodiment, and thus the present invention is not limited to them. Further, as far as singular expression clearly denotes a different meaning in context, it includes plural expression. It is understood that terms “comprises”, “comprising”, “includes” or “has” intend to indicate the existence of features, numerals, steps, operations, elements and components described in the specification or the existence of the combination of these, and do not exclude the existence of one or more other features, numerals, steps, operations, elements and components or the existence of the combination of these or additional possibility beforehand.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

In the present invention, the term “cap shape” used herein generally denotes a pole of plane figure, such as a cylinder, a square pole, a pentagonal pole and a star-shaped pole, or an equivalent level of solid figure. For example, a lower base side of the cylinder is opened and an upper base side thereof is blocked. Hereinafter, the base side being opened is called as an “opened base side”, and the base side being blocked is called as a “blocked base side”.

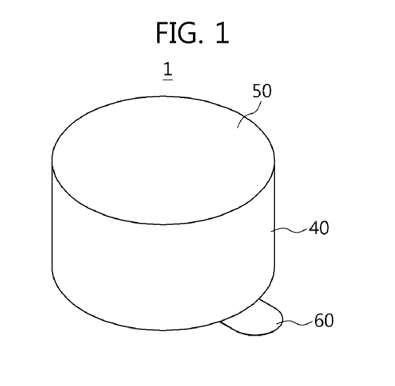

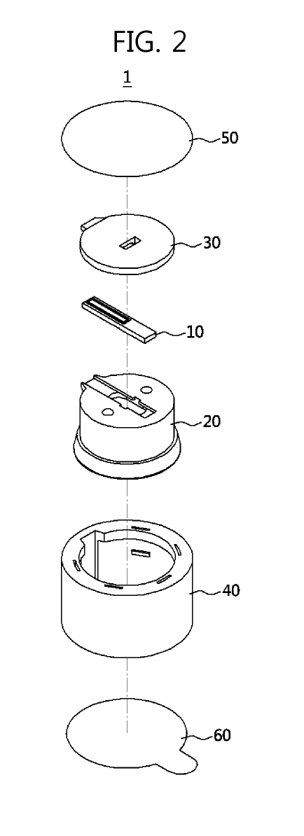

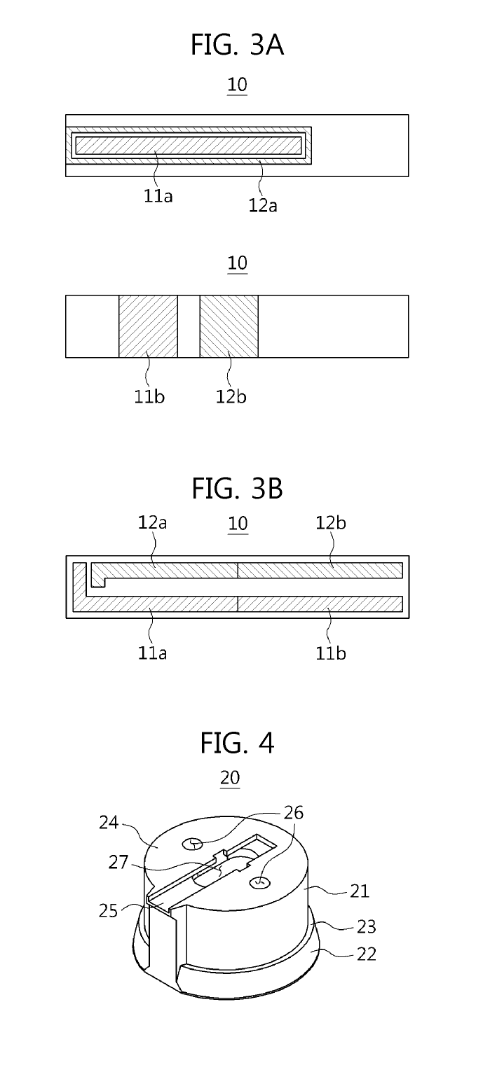

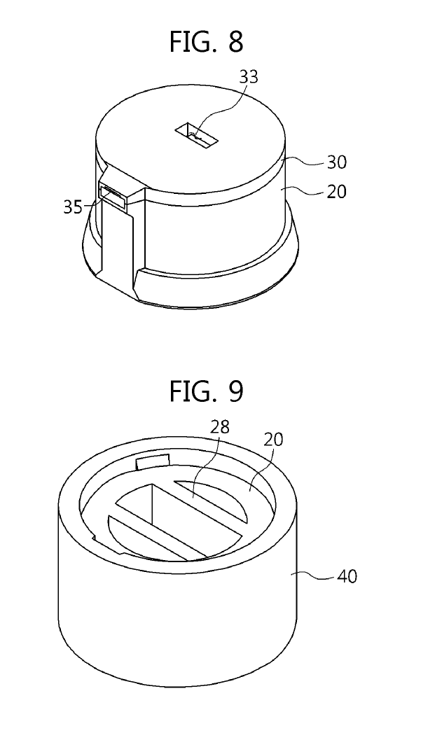

Referring to FIGS. 1 to 10, a module type biosensor 1 according to one exemplary embodiment of the present invention may include a reaction substrate 10 which reacts with a sample and generates a reaction signal, and a lower structure body 20 which has a cap shape, and in which the reaction substrate 10 is coupled to a cap-shaped blocked base side 24, and a detector 80 performing an analysis of an introduced sample based on the reaction signal generated from the reaction substrate 10 is inserted and coupled into a cap-shaped opened base side so as to be in contact with the reaction substrate 10. The module type biosensor 1 may further include an upper structure body 30 forming a reaction chamber which is coupled to the blocked base side 24 of the lower structure body 20 and generates the reaction signal when being coupled to the blocked base side 24 of the lower structure body 20. The reaction chamber is an area in a capillary groove 34 (a sample introducing passage or a fine passage), in which the reaction occurs. An opened side of the capillary groove 34 forms an introduction port 35 through which a sample is introduced into the reaction substrate 10. The upper structure body 30 may further include a vent hole 33 through which air introduced together with the introduction of the sample through the introduction port 35 is discharged. The reaction substrate 10 reacts with the sample (or a target biological substance contained in the sample), generates the reaction signal and then transfers the generated reaction signal to the detector 80. Referring to FIG. 3A, in the reaction substrate 10, a working electrode 11a and a reference electrode 12a may be formed at one surface thereof, and an operation signal transferring electrode 11b which is electrically connected with the working electrode 11a and a reference signal transferring electrode 12b which is electrically connected with the reference electrode 12a may be formed at the other surface thereof. At this time, the working electrode 11a may have a quadrangular shape, and the reference electrode 12a may have a hollow quadrangular shape so as to enclose the working electrode 11a. The working electrode 11a and the operation signal transferring electrode 12b formed at the one surface of the reaction substrate 10 and the reference electrode 12a and the reference signal transferring electrode 12b formed at the other surface thereof may be electrically connected through a via hole (not shown).

Alternatively, as illustrated in FIG. 3B, all of the working electrode 11a, the reference electrode 12a, the operation signal transferring electrode 11b which is electrically connected with the working electrode 11a and the reference signal transferring electrode 12b which is electrically connected with the reference electrode 12a may be formed at the same surface of the reaction substrate 10.

A reaction reagent (not shown) reacts with the introduced sample may be provided at an upper side of the working electrode 11 a and the reference electrode 12a.

The reaction substrate 10 is formed as a printed circuit board (PCB) or a flexible printed circuit board (FPCB) in which the substrate and the electrode are formed integrally.

Further, positions and shapes of the working electrode 11a, the reference electrode 12a, the operation signal transferring electrode 11b and the reference signal transferring electrode 12b of the reaction substrate 10 are not limited to the above description. That is, the working electrode 11a and the reference electrode 12a may be formed at all positions which may react with the introduced sample and generate the reaction signal, and the operation signal transferring electrode 11b and the reference signal transferring electrode 12b may be formed at all positions which may transfer the generated reaction signal to the detector.

Referring to FIG. 4, the lower structure body 20 has a hollow cylinder shape. A first outer diameter portion 21 and a second outer diameter portion 22 having a larger radius than the first outer diameter portion 21 are formed at an outer surface of the hollow cylinder so as to be adjacent to each other up and down, and a first stepped surface 23 is formed at a boundary portion between the first outer diameter portion 21 and the second outer diameter portion 22.

At this time, in order for the lower structure body 20 to slide along a housing 40, a radius of the first outer diameter portion 21 is formed to be smaller than that of a first inner diameter portion 41, and a radius of the second outer diameter portion 22 is formed to be smaller than that of a second inner diameter portion 42. Further, the radius of the second outer diameter portion 22 is formed to be larger than that of the first inner diameter portion 41 so that the lower structure body 20 is prevented from sliding and separating from the housing 40. That is, since the radius of the second outer diameter portion 22 is formed to be larger than that of the first inner diameter portion 41, when the lower structure body 20 slides along the housing 40, the first stepped surface 23 is caught by a second stepped surface 43, and the lower structure body 20 is prevented from separating from the housing 40.

Further, the blocked base side 24 is formed to extend from an end of the first outer diameter portion 21 toward an inner side (i.e., a central side of the hollow cylinder). Further, the shape of the lower structure body 20 is limited to the above description. For example, the lower structure body 20 may have a hollow polygonal pole shape (a triangular pole, a quadrangular pole, a pentagonal pole or the like) having the blocked base side provided at one end thereof.

Further, a first coupling groove 25 to which the reaction substrate 10 is coupled and a first coupling hole 26 to which the upper structure body 30 is coupled are formed at the blocked base side 24 of the lower structure body 20. The first coupling groove 25 is formed to correspond to a shape of the reaction substrate 10. For example, when the reaction substrate 10 has a bar shape, the first coupling groove 25 is formed so that the bar-shaped reaction substrate 10 may be coupled. A surface area of the first coupling groove 25 may be formed to be the same as that of one surface of the reaction substrate 10. Further, the first coupling groove 25 is formed so that one of four side surfaces thereof facing an outer circumferential surface of the lower structure body 20 is opened, and thus one side surface of the reaction substrate 10 is exposed to an outside. Further, the reaction substrate 10 may be coupled to the first coupling groove 25 in a thermal bonding manner, a ultrasonic bonding manner, a bonding manner, a fitting manner or the like.

The first coupling hole 26 serves to couple the upper structure body 30 to the lower structure body 20, and a radius of the first coupling hole 26 is formed to be smaller than that of a coupling protrusion 32, such that the coupling protrusion 32 is press-fitted into the first coupling hole 26. Further, at least one first coupling hole 26 is formed at the blocked base side 24, and a shape of the first coupling hole 26 is limited to a circle, may be formed to have various shapes such as a triangular shape, a quadrangular shape and a pentagonal shape.

Further, a second coupling hole 27 which allows the operation signal transferring electrode 11b and the reference signal transferring electrode 12b of the reaction substrate 10 to be in contact with the detector 80 is formed at a predetermined area of the first coupling groove 25. Further, a size and a position of the second coupling hole 27 formed in the first coupling groove 25 may be differed according to a size and a position of the operation signal transferring electrode 11b and the reference signal transferring electrode 12b formed in the reaction substrate 10 coupled to the first coupling groove 25.

Further, the lower structure body 20 further includes an inner side wall 28 which is formed to extend from the blocked base side 24 toward an end of the second outer diameter portion 22. A dehumidifying agent may be received in a receiving space defined by the blocked base side 24, the first outer diameter portion 21, the second outer diameter portion 22 and the inner side wall 28.

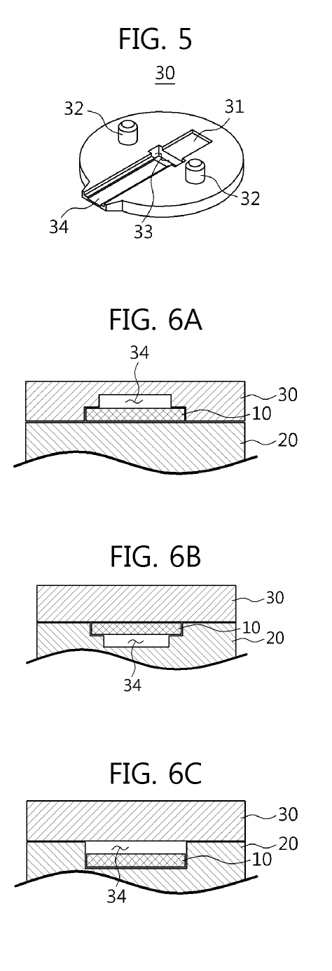

The reaction substrate 10 and the lower structure body 20 are coupled to the upper structure body 30. Referring to FIG. 5, the upper structure body 30 has a flat plate shape, and a 1-1^{st} coupling groove 31 and the coupling protrusion 32 are formed at one surface of the flat plate. Further, a shape of the upper structure body 30 may be formed to be the same as that of the block base side 24.

The 1-1^{st} coupling groove 31 is formed to have the same shape as the first coupling groove 25, and the reaction substrate 10 is coupled to the 1-1^{st} coupling groove 31. That is, the 1-1^{st} coupling groove 31 has the same size as the first coupling groove. The 1-1^{st} coupling groove 31 is formed on the upper structure body 30 so as to face the first coupling groove 25 when the upper structure body 30 is coupled to the lower structure body 20. Further, the 1-1^{st} coupling groove 31 is formed so that one side surface of the reaction substrate 10 is exposed to the outside when the upper structure body is coupled to the lower structure body 20 coupled with the reaction substrate 10. That is, the 1-1^{st} coupling groove 31 is formed so that one of four side surfaces thereof is opened. Also, the reaction substrate 10 may be coupled to the 1-1^{st} coupling groove 31 in the thermal bonding manner, the ultrasonic bonding manner, the bonding manner, the fitting manner or the like.

The coupling protrusion 32 is press-fitted into the first coupling hole 26 so as to couple the lower structure body 20 and the upper structure body 30. The coupling protrusion 32 is formed to corresponding to the shape of the first coupling hole 26. That is, a radius of the coupling protrusion 32 is formed to be larger than that of the first coupling hole 26, such that the coupling protrusion 32 may be press-fitted and coupled into the first coupling hole 26. Further, at least one coupling protrusion 32 is formed at the upper structure body 30, and the number of the coupling protrusions 32 is the same as that of the first coupling holes 26.

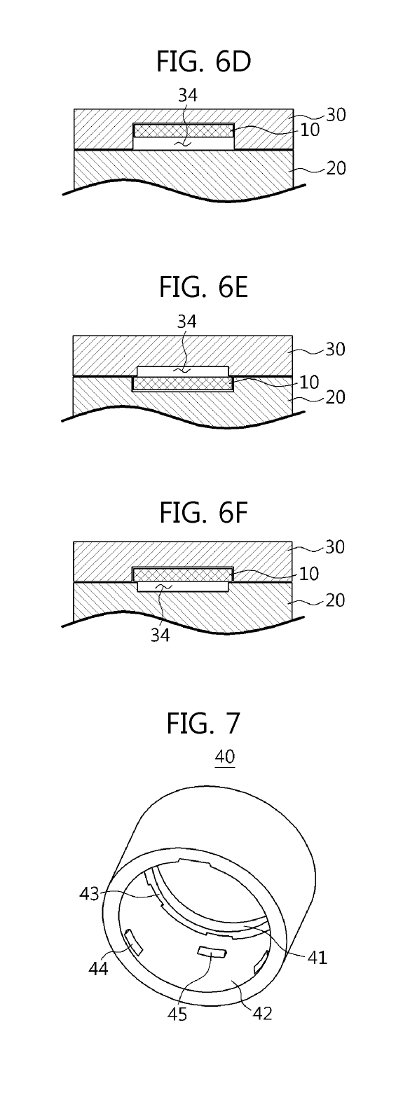

Also, the vent hole 33 and the capillary groove 34 are formed at the 1-1^{st} coupling groove 31 of the upper structure body 30. The vent hole 33 serves to discharge the air introduced together with the introduction of the sample through the introduction port 35, and is formed to be spaced apart from the introduction port 35. The introduction port 35 serves to introduce the sample to the reaction substrate 10, and is a space defined by one end of the reaction substrate 10 coupled to the lower structure body 20 and one end of the upper structure body 30. The capillary groove 34 is formed in the 1-1^{st} coupling groove 31 in a lengthwise direction of the reaction substrate 10, and one end of the capillary groove 34 is connected with the introduction port 35, and the other end thereof is connected with the vent hole 33. That is, the sample introduced through the introduction port 35 is quickly transported to the working electrode 11a and the reference electrode 12a of the reaction substrate 10 by a capillary phenomenon, and the vent hole 33 discharges the air received in the capillary groove 34 due to the introduction of the sample to the outside. Also, positions of the vent hole 33, the capillary groove 34 and the introduction port 35 are not limited to the above-mentioned description. The vent hole 33, the capillary groove 34 and the introduction port 35 may be formed at the first coupling groove 25. This will be described with reference to FIGS. 6A to 6F.

Referring to FIG. 6A, the reaction substrate 10 is coupled to the 1-1^{st} coupling groove 31 formed at the one surface of the upper structure body 30, and the capillary groove 34 may be formed between the reaction substrate 10 and the upper structure body 30. Although not shown in the drawings, the 1-1^{st} coupling groove 31 means a groove to which the reaction substrate is coupled. Referring to FIG. 6B, the reaction substrate 10 is coupled to the 1-1^{st} coupling groove 31 formed at the one surface of the lower structure body 20, and the capillary groove 34 may be formed between the reaction substrate 10 and the lower structure body 20. Referring to FIG. 6C, the reaction substrate 10 is coupled to the 1-1^{st} coupling groove 31 formed at the one surface of the lower structure body 20, and the capillary groove 34 may be formed between the reaction substrate 10 and the upper structure body 30. Referring to FIG. 6D, the reaction substrate 10 is coupled to the 1-1^{st} coupling groove 31 formed at the one surface of the upper structure body 30, and the capillary groove 34 may be formed between the reaction substrate 10 and the lower structure body 20. Referring to FIG. 6E, the reaction substrate 10 is coupled to the 1-1^{st} coupling groove 31 formed at the one surface of the lower structure body 20, and the capillary groove 34 may be formed at an area of the one surface of the upper structure body 30 corresponding to the reaction substrate 10. Referring to FIG. 6F, the reaction substrate 10 is coupled to the 1-1^{st} coupling groove 31 formed at the one surface of the upper structure body 30, and the capillary groove 34 may be formed at an area of the one surface of the lower structure body 20 corresponding to the reaction substrate 10. In FIGS. 6A, 6C and 6E, the working electrode 11a and the reference electrode 12a are formed at one surface of the reaction substrate 10, and the operation signal transferring electrode 11b and the reference signal transferring electrode 12b are formed at the other surface thereof, as illustrate in FIG. 3A. However, In FIGS. 6B, 6D and 6F, all of the working electrode 11a, the reference electrode 12a, the operation signal transferring electrode 11b and the reference signal transferring electrode 12b of the reaction substrate 10 are formed at the same surface thereof, as illustrate in FIG. 3B. In these various coupling types, another air discharging means such as a vent slit, instead of the vent hole 33, may be provided. For example, a space is formed between both side surfaces of the reaction substrate 10 and the 1-1^{st} coupling groove 31 so that the air is discharged therethrough.

As described above, the module type biosensor 1 may be formed by coupling the reaction substrate 10 to the lower structure body 20 and the upper structure body 30. When the detector 80 is coupled to the lower structure body 20 to which the reaction substrate 10 is coupled through the module type biosensor 1, the reaction substrate 10 is in contact with the detector 80, and thus the reaction substrate 10 and the detector 80 may be easily in contact with each other.

That is, the lower structure body 20 to which the reaction substrate 10 is coupled has a larger volume than the reaction substrate 10, and the detector 80 may be easily coupled to the lower structure body 20 having such a volume, and thus it is possible to provide an advantage that the reaction substrate 10 and the detector 80 may be easily in contact with each other. Furthermore, since the reaction substrate 10 is located inside the lower structure body 20 and the upper structure body 30, it is possible to prevent the reaction substrate 10 from being exposed to the outside and contaminated.

Also, when the reaction substrate 10 is separated from the detector 80, the reaction substrate 10 may be easily separated from the detector 80 by grasping the lower structure body 20, to which the reaction substrate 10 is coupled, with a hand and removing the lower structure body 20. Therefore, convenience and sanitation are enhanced, compared with the conventional case in which a user pulls a portion containing blood with a hand.

Also, the module type biosensor 1 according to one embodiment of the present invention may further include a housing 40 which is formed to enclose outer surfaces of the lower structure body 20 and the upper structure body 30 and slides along the outer surfaces of the lower structure body 20 and the upper structure body 30.

The housing 40 is formed to enclose outer surfaces of the lower structure body 20 and the upper structure body 30 and thus to protect the reaction substrate 10 exposed through the introduction port 35. As illustrate in FIG. 7, the housing 40 has a hollow cylinder shape. The first inner diameter portion 41 and the second inner diameter portion 42 having a larger radius than the first inner diameter portion 41 are formed at an inner circumferential surface of the hollow cylinder so as to be adjacent to each other up and down, and a second stepped surface 43 is formed at a boundary portion between the first inner diameter portion 41 and the second inner diameter portion 42.

At this time, in order for the housing 40 to slide along the lower structure body 20, a radius of the first inner diameter portion 41 is formed to be larger than that of the first outer diameter portion 21, and a radius of the second inner diameter portion 42 is formed to be larger than that of the second outer diameter portion 22. Further, the radius of the first inner diameter portion 41 is formed to be smaller than that of the second outer diameter portion 22 so that the housing 40 is prevented from sliding and separating from the lower structure body 20. That is, since the radius of the first inner diameter portion 41 is formed to be smaller than that of the second outer diameter portion 22, when the housing 40 slides along the lower structure body 20, the second stepped surface 43 is caught by the first stepped surface 23, and the housing 40 is prevented from separating from the lower structure body 20.

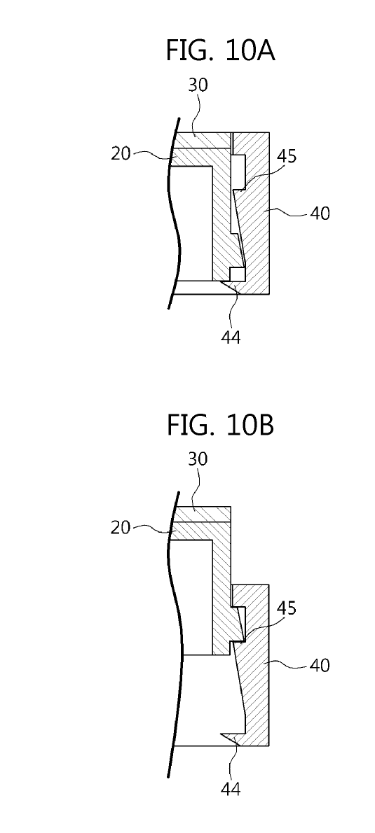

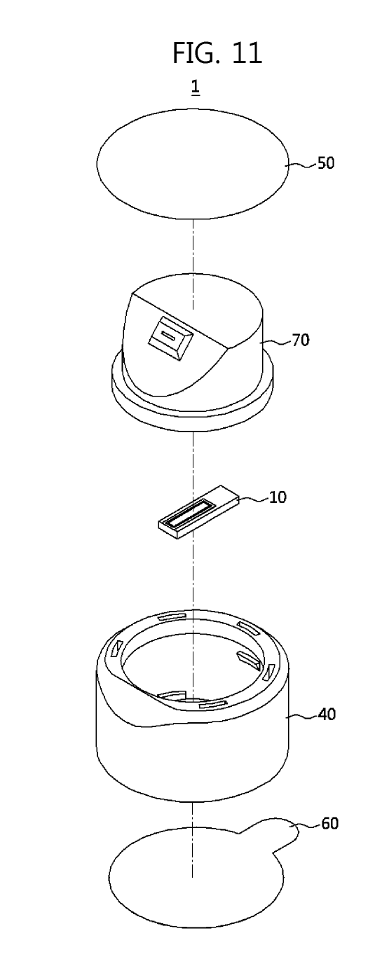

Further, catching protrusions 44, 45 which prevent separation of the lower structure body 20 may be formed on an inner surface of the second inner diameter portion 42 so as to be spaced apart at equidistant intervals. As illustrated in FIGS. 10A and 10B, the catching protrusions 44, 45 may further include a lower catching protrusion 44 which prevents the separation of the lower structure body 20 received in the housing 40, and an upper catching protrusion 45 which maintains a protruding state when the lower structure body 20 protrudes to the outside of the housing 40.

That is, as illustrate in FIG. 10A, when the lower structure body 20 and the upper structure body 30 are received in the housing 40, at least one lower catching protrusion 44 is formed at the second inner diameter portion 42 in order to prevent the lower structure body from separating from the housing 40.

Further, as illustrated in FIG. 10B, when the lower structure body 20 protrudes to the outside of the housing 40, at least one upper catching protrusion 45 is formed at the second inner diameter portion 42 of the housing 40 in order to maintain the state in which the lower structure body 20 protrudes to the outside of the housing 40. The upper catching protrusion 45 is formed between the lower catching protrusion 44 and the first inner diameter portion 41.

Further, the lower catching protrusion 44 and the upper catching protrusion 45 may be formed to be inclined toward the second inner diameter portion 42, and a catching portion may be formed toward the first inner diameter portion 41. For example, the lower catching protrusion 44 and the upper catching protrusion 45 have an inverted right-angled triangular shape. Therefore, the lower structure body 20 may easily slide along the housing 40 toward the first inner diameter portion 41, and the lower structure body 20 sliding along the housing 40 toward the first inner diameter portion 41 is fixed and thus does not slide toward the second inner diameter portion 42.

Further, the module type biosensor 1 according to one embodiment of the present invention may further include an upper cover 50 which is attached to one end of the housing 40 and protects the reaction substrate 10 exposed to the outside through the upper structure body 30, and a lower cover 60 which is attached to the other end of the housing 40 and protects the reaction substrate 10 exposed to the outside through the lower structure body 20.

The upper cover 50 and the lower cover 60 prevent exposure of the reaction substrate 10 (or a reagent coated on the reaction substrate 10). A handle may be provided at the upper cover 50 and the lower cover 60 in order to easily remove the upper cover 50 and the lower cover 60. The upper cover 50 and the lower cover 60 may be formed of a sticker or a thin film.

Further, the lower structure body 20, the upper structure body 30 and the housing 40 may be formed of a synthetic resin such as plastic. Further, since they may be manufacture by injection molding, it is possible to easily change the shapes thereof.

FIG. 20 illustrates a state in which the detector 80 is coupled to the module type biosensor 1 of FIG. 1. The detector 80 is coupled in a state in which the lower cover 60 of the module type biosensor 1 is removed. The detector 80 is inserted and coupled from a side of the second outer diameter portion 22 of the lower structure body 20, and at this time, the lower structure body 20 and the upper structure body 30 slides along the housing 40. Therefore, the lower structure body 20 and the upper structure body 30 are exposed to the outside of the housing 40, and thus the introduction port 35 for introducing the sample is exposed to the outside. Further, as the lower structure body 20 and the upper structure body 30 are exposed to the outside of the housing 40, the upper cover 50 attached to the housing 40 is automatically removed. Then, if the sample is introduced to the introduction port 35 exposed to the outside, the sample is quickly transported to the reaction substrate 10 by the capillary phenomenon at the capillary groove 34. The sample transported to the reaction substrate 10 causes an oxidation-reduction reaction with a chemical substance, and the reaction signal is generated from the working electrode 11 a and the reference electrode 12a, and the generated reaction signal are transferred to the operation signal transferring electrode 11b and the reference signal transferring electrode 12b, and the reaction signal transferred to the operation signal transferring electrode 11b and the reference signal transferring electrode 12b is transferred to the detector 80 which is in contact with the operation signal transferring electrode 11b and the reference signal transferring electrode 12b.

As described above, the module type biosensor 1 may be formed by coupling the reaction substrate 10 to the lower structure body 20 and the upper structure body 30, coupling the housing 40 to the lower structure body 20 to which the reaction substrate 10 is coupled, and attaching the upper cover 50 and the lower cover 60 to the housing 40.

So far, the module type biosensor according to one embodiment of the present invention has been described fully. Hereinafter, a module type biosensor according to another embodiment of the present invention will be described.

Referring to FIGS. 11 to 14B, a module type biosensor 1 according to another embodiment of the present invention includes a reaction substrate 10 which reacts with a sample and generates a reaction signal, and a main structure body 70 which has a hollow shape and in which a first outer diameter portion 21 and a second outer diameter portion 22 having a larger radius than the first outer diameter portion 21 are formed at an outer surface of the hollow shape so as to be adjacent to each other up and down, and a first stepped surface 23 is formed at a boundary portion between the first outer diameter portion 21 and the second outer diameter portion 22, and a blocked base side 24 is formed to extend to an inner side of an end of the first outer diameter portion 21, and a 1-1^{st} coupling groove 31 for coupling a reaction substrate 10 is formed at one surface of the blocked base side 24 facing the second outer diameter portion 22, and an introduction port 35 for introducing a sample to the reaction substrate 10 coupled to the 1-1^{st} coupling groove 31 is formed at the first outer diameter portion 21, and a capillary groove 34 for quickly transport the sample introduced through the introduction port 35 to the reaction substrate 10 is formed at the 1-1^{st} coupling groove 31.

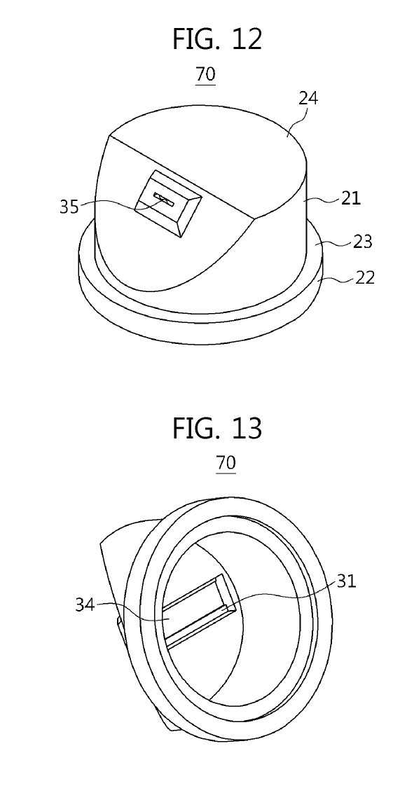

The reaction substrate 10 reacts with the introduced sample, generates the reaction signal and transfers the generated reaction signal to the detector 80. The reaction substrate 10 of FIG. 11 is the same as the reaction substrate 10 of FIGS. 3A and 3B. The reaction substrate 10 and the detector 80 are coupled to the main structure body 70. Referring to FIGS. 12 and 13, the main structure body 70 has the hollow cylinder shape. The first outer diameter portion 21 and the second outer diameter portion 22 having a larger radius than the first outer diameter portion 21 are formed at an outer circumferential surface of the main structure body 70 so as to be adjacent to each other up and down, and the first stepped surface 23 is formed at the boundary portion between the first outer diameter portion 21 and the second outer diameter portion 22.

At this time, in order for the main structure body 70 to slide along a housing 40, a radius of the first outer diameter portion 21 is formed to be smaller than that of a first inner diameter portion 41, and a radium of the second outer diameter portion 22 is formed to be smaller than that of the second inner diameter portion 42. Further, in order to prevent the main structure body 70 from sliding and separating from the housing 40, a radius of the second outer diameter portion 22 is formed to be larger than the first inner diameter portion 41. That is, since the radius of the second outer diameter portion 22 is formed to be larger than the first inner diameter portion 41, when the main structure body 70 slides along the housing 40, the first stepped surface 23 is caught by a second stepped surface 43, and thus the main structure body 70 is prevented from separating from the housing 40.

Further, the blocked base side 24 is formed to extend from an end of the first outer diameter portion 21 toward an inner side (i.e., a central side of the hollow cylinder). That is, the main structure body 70 has the hollow cylinder shape having the blocked base side at one end thereof, i.e., a cap shape. Further, the shape of the main structure body 70 is limited to the above description. For example, the main structure body 70 may have a hollow polygonal pole shape (a triangular pole, a quadrangular pole, a pentagonal pole or the like) having the blocked base side provided at one end thereof.

Further, the 1-1^{st} coupling groove 31 to which the reaction substrate 10 is coupled is formed at an inner surface of the base side 24 (i.e., the blocked base side facing the second outer diameter portion 22). The 1-1^{st} coupling groove 31 is formed to correspond to the shape of the reaction substrate 10. For example, when the reaction substrate 10 has a bar shape, the 1-1^{st} coupling groove 31 is formed so that the bar-shaped reaction substrate 10 may be coupled. The reaction substrate 10 may be coupled to the 1-1^{st} coupling groove 31 in a thermal bonding manner, a ultrasonic bonding manner, a bonding manner, a fitting manner or the like.

The introduction port 35 for introducing the sample to the reaction substrate 10 coupled to the 1-1^{st} coupling groove 31 is formed at the first outer diameter portion 21, and one side surface of the first outer diameter portion 21, at which the introduction port 35 is formed, may be formed to be inclined. The capillary groove 34 serves to guide the introduction of the sample through the capillary phenomenon. The capillary groove 34 is formed at the 1-1^{st} coupling groove 31 in a lengthwise direction of the reaction substrate 10, and one end of the capillary groove 34 is connected to the introduction port 35. That is, the sample introduced through the introduction port 35 is quickly transported to the working electrode 11a and the reference electrode 12a of the reaction substrate 10 by the capillary phenomenon of the capillary groove 34.

Further, a vent hole (not shown) for discharging air received in the capillary groove 34 together with the introduction of the sample may be formed at the 1-1^{st} coupling groove 31. At this time, the vent hole is formed at the other end of the capillary groove 34. That is, the introduction port 35 is formed at the one end of the capillary groove 34, and the vent hole is formed at the other end thereof, and thus the sample introduced from the introduction port 35 may be quickly transported to the reaction substrate 10 through the capillary groove 34, and the air received in the capillary groove 34 together with the introduction of the sample may be discharged through the vent hole.

Further, the main structure body 70 further includes an inner side wall 28 which is formed to extend from the blocked base side 24 toward an end of the second outer diameter portion 22. A dehumidifying agent may be received in a receiving space defined by the blocked base side 24, the first outer diameter portion 21, the second outer diameter portion 22 and the inner side wall 28.

Further, the module type biosensor 1 may further include the housing 40 which is formed to enclose the outer surface of the main structure body 70 and also to slide along the outer circumferential surface of the main structure body 70. The housing 40 has a hollow cylinder shape. The first inner diameter portion 41 and the second inner diameter portion 42 having a larger radius than the first inner diameter portion 41 are formed at an inner circumferential surface of the hollow cylinder so as to be adjacent to each other up and down, and the second stepped surface 43 is formed at a boundary portion between the first inner diameter portion 41 and the second inner diameter portion 42.

At this time, in order for the housing 40 to slide along the main structure body 70, a radius of the first inner diameter portion 41 is formed to be larger than that of the first outer diameter portion 21, and a radius of the second inner diameter portion 42 is formed to be larger than that of the second outer diameter portion 22. Further, the radius of the first inner diameter portion 41 is formed to be smaller than that of the second outer diameter portion 22 so that the housing 40 is prevented from sliding and separating from the main structure body 70.

Further, catching protrusions 44, 45 which prevent separation of the main structure body 70 may be formed on an inner surface of the second inner diameter portion 42. The catching protrusions 44, 45 may further include a lower catching protrusion 44 which prevents the separation of the main structure body 70 received in the housing 40, and an upper catching protrusion 45 which maintains a protruding state when the main structure body 70 protrudes to the outside of the housing 40.

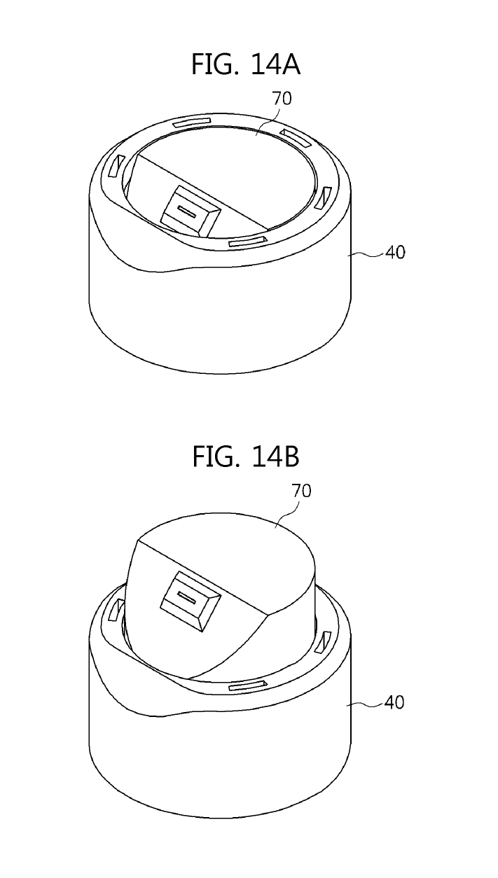

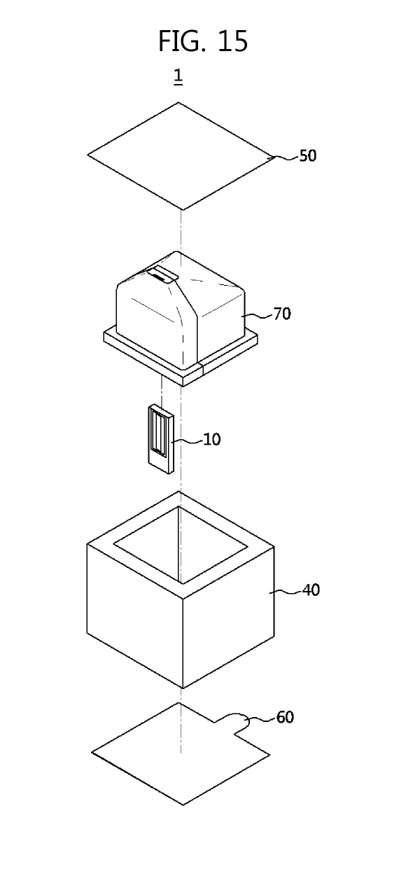

That is, as illustrated in FIG. 14A, when the main structure body 70 is received in the housing 40, and thus only the blocked base side 24 and the second outer diameter portion 22 are exposed to the outside, at least one lower catching protrusion 44 is formed at the second inner diameter portion 42 in order to prevent the main structure body 70 from separating toward an end of the second inner diameter portion 42 of the housing 40.

Further, as illustrated in FIG. 14B, when the main structure body 70 protrudes to the outside of the housing 40, at least one upper catching protrusion 45 is formed at the second inner diameter portion 42 in order to maintain the state in which the main structure body 70 protrudes to the outside of the housing 40.

The module type biosensor 1 may further include an upper cover 50 and a lower cover 60 which are attached to one end and the other end of the housing 40 and protects the reaction substrate 10 exposed to the outside through the main structure body 70.

A handle may be provided at the upper cover 50 and the lower cover 60 in order to easily remove the upper cover 50 and the lower cover 60.

Further, the main structure body 70 and the housing 40 may be formed of a synthetic resin such as plastic. Further, since they may be manufacture by injection molding, it is possible to easily change the shapes thereof.

Further, a method of coupling the detector to the module type biosensor 1 of the FIG. 11 is the same as in FIG. 20.

So far, the module type biosensor according to another embodiment of the present invention has been described fully. Hereinafter, a module type biosensor according to still another embodiment of the present invention will be described.

Referring to FIGS. 15 to 19B, a module type biosensor 1 according to still another embodiment of the present invention includes a reaction substrate 10 which reacts with a sample and generates a reaction signal, and a main structure body 70 which has a hollow shape and in which a first outer diameter portion 21 and a second outer diameter portion 22 having a larger width than the first outer diameter portion 21 are formed at an outer surface of the hollow shape so as to be adjacent to each other up and down, and a first stepped surface 23 is formed at a boundary portion between the first outer diameter portion 21 and the second outer diameter portion 22, and a blocked base side 24 is formed to extend to an inner side of an end of the first outer diameter portion 21, and a 1-1^{st} coupling groove 31 for coupling a reaction substrate 10 is formed at an inner surface of the first outer diameter portion 21, and an introduction port 35 for introducing a sample to the reaction substrate 10 coupled to the 1-1^{st} coupling groove 31 is formed at the blocked base side 24, and a capillary groove 34 for quickly transport the sample introduced through the introduction port 35 to the reaction substrate 10 is formed at the 1-l^{st} coupling groove 31.

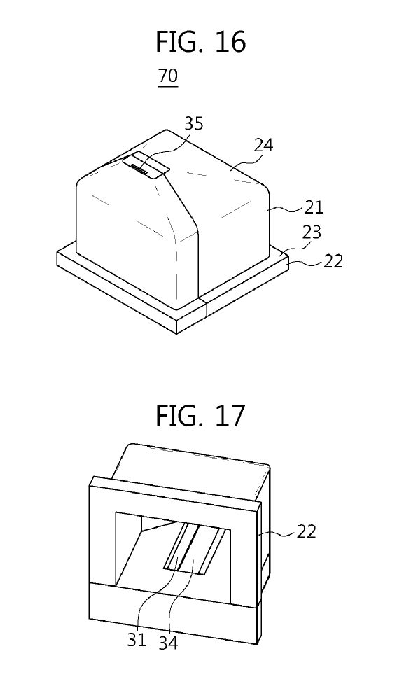

The reaction substrate 10 reacts with the introduced sample, generates the reaction signal and transfers the generated reaction signal to the detector 80. The reaction substrate 10 of FIG. 15 is the same as the reaction substrate 10 of FIGS. 3A and 3B. The reaction substrate 10 and the detector 80 are coupled to the main structure body 70. Referring to FIGS. 15 and 16, the main structure body 70 has the hollow quadrangular pole shape. The first outer diameter portion 21 and the second outer diameter portion 22 having a larger width than the first outer diameter portion 21 are formed at an outer surface of the hollow quadrangular pole so as to be adjacent to each other up and down, and the first stepped surface 23 is formed at the boundary portion between the first outer diameter portion 21 and the second outer diameter portion 22. The width is a distance between facing quadrangular surfaces in the hollow quadrangular pole.

At this time, in order for the main structure body 70 to slide along a housing 40, a width of the first outer diameter portion 21 is formed to be smaller than that of a first inner diameter portion 41, and a width of the second outer diameter portion 22 is formed to be smaller than that of the second inner diameter portion 42. Further, in order to prevent the main structure body 70 from sliding and separating from the housing 40, a width of the second outer diameter portion 22 is formed to be larger than the first inner diameter portion 41.

Further, the blocked base side 24 is formed to extend from an end of the first outer diameter portion 21 toward an inner side (i.e., a central side of the hollow quadrangular pole). That is, the main structure body 70 has the hollow quadrangular pole shape having the blocked base side at one end thereof, i.e., a cap shape. Further, the shape of the main structure body 70 is limited to the above description.

Further, the 1-1^{st} coupling groove 31 to which the reaction substrate 10 is coupled is formed at an inner surface of the base side 24. That is, since the main structure body 70 has the hollow quadrangular pole shape, the 1-1^{st} coupling groove 31 is formed at an inner side of one of four side surfaces forming the hollow quadrangular pole. The 1-1^{st} coupling groove 31 is formed to correspond to the shape of the reaction substrate 10. For example, when the reaction substrate 10 has a bar shape, the 1-1^{st} coupling groove 31 is formed so that the bar-shaped reaction substrate 10 may be coupled. Further, the reaction substrate 10 may be coupled to the 1-1^{st} coupling groove 31 in a thermal bonding manner, a ultrasonic bonding manner, a bonding manner, a fitting manner or the like.

Further, the introduction port 35 for introducing the sample to the reaction substrate 10 coupled to the 1-1^{st} coupling groove 31 is formed at the blocked base side 24. The capillary groove 34 is formed in the 1-1^{st} coupling groove 31 in a lengthwise direction of the reaction substrate, and one end of the capillary groove 34 is connected to the introduction port 35. That is, the sample introduced through the introduction port 35 is quickly transported to the working electrode 11a and the reference electrode 12a of the reaction substrate 10 by the capillary phenomenon of the capillary groove 34.

Further, a vent hole (not shown) for discharging air received in the capillary groove 34 together with the introduction of the sample may be formed at the 1-1^{st} coupling groove 31.

Further, the main structure body 70 further includes an inner side wall 28 which is formed to extend from the blocked base side 24 toward an end of the second outer diameter portion 22. A dehumidifying agent may be received in a receiving space defined by the blocked base side 24, the first outer diameter portion 21, the second outer diameter portion 22 and the inner side wall 28.

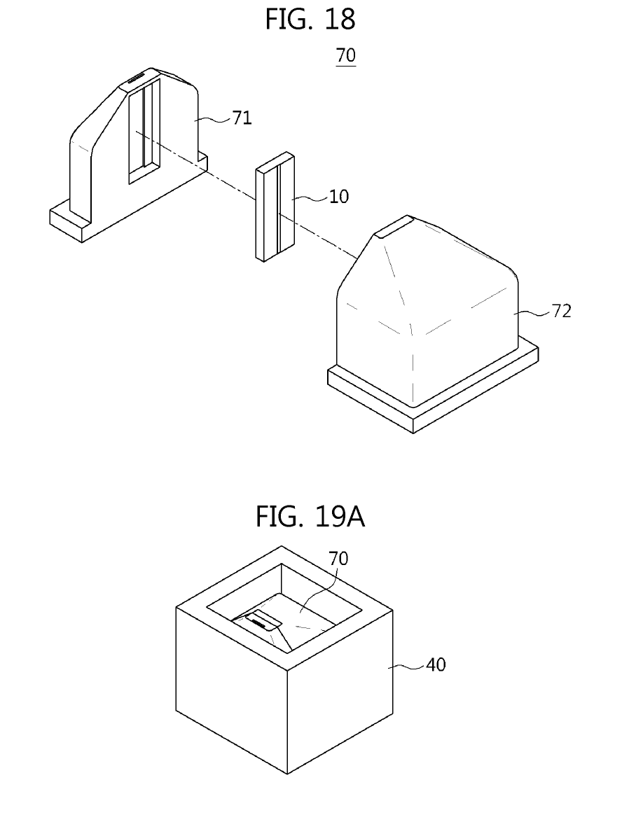

Further, in the above description, a case in which the main structure body 70 is formed as one structure body has been described. However, the main structure body 70 may be formed as two structure bodies. That is, as illustrate in FIG. 18, the main structure body 70 may be divided into a first structure body 71 and a second structure body 72 based on the inner side surface of the first outer diameter portion 21. Here, structures and arrangement of the 1-1^{st} coupling groove 31 and the capillary groove 34 may be formed to be the same as those in FIGS. 6A to 6F. At this time, the first structure body 71 may correspond to the upper structure body 30, and the second structure body 72 may correspond to the lower structure body 20.

Further, the module type biosensor 1 may further include the housing 40 which is formed to enclose the outer surface of the main structure body 70 and also to slide along the outer surface of the main structure body 70. The housing 40 is formed to enclose the outer surface of the main structure body 70 and protects the reaction substrate 10 exposed to the introduction port 35. The housing 40 illustrated in FIG. 15 has a different shape from the housing 40 illustrated in FIG. 6, but has the same function and configuration. That is, the housing 40 has the hollow quadrangular pole shape, and the first inner diameter portion 41 and the second inner diameter portion 42 which has a larger width than the first inner diameter portion 41 are formed at the inner surface of the hollow quadrangular pole so as to be adjacent to each other up and down, and a second stepped surface 43 is formed at a boundary portion between the first inner diameter portion 41 and the second inner diameter portion 42. The width is a distance between facing quadrangular surfaces in the hollow quadrangular pole.

At this time, in order for the housing 40 to slide along the main structure body 70, a width of the first inner diameter portion 41 is formed to be larger than that of the first outer diameter portion 21, and a width of the second inner diameter portion 42 is formed to be larger than that of the second outer diameter portion 22. Further, in order to prevent the housing 40 from sliding and separating from the main structure body 70, a width of the first inner diameter portion 41 is formed to be smaller than the second outer diameter portion 22.

Further, catching protrusions 44, 45 which prevent separation of the main structure body 70 may be formed at the second inner diameter portion 42. Further, the catching protrusion 44, 45 may further include a lower catching protrusion 44 which prevents the separation of the main structure body 70 received in the housing 40, and an upper catching protrusion 45 which maintains a protruding state when the main structure body 70 protrudes to the outside of the housing 40.

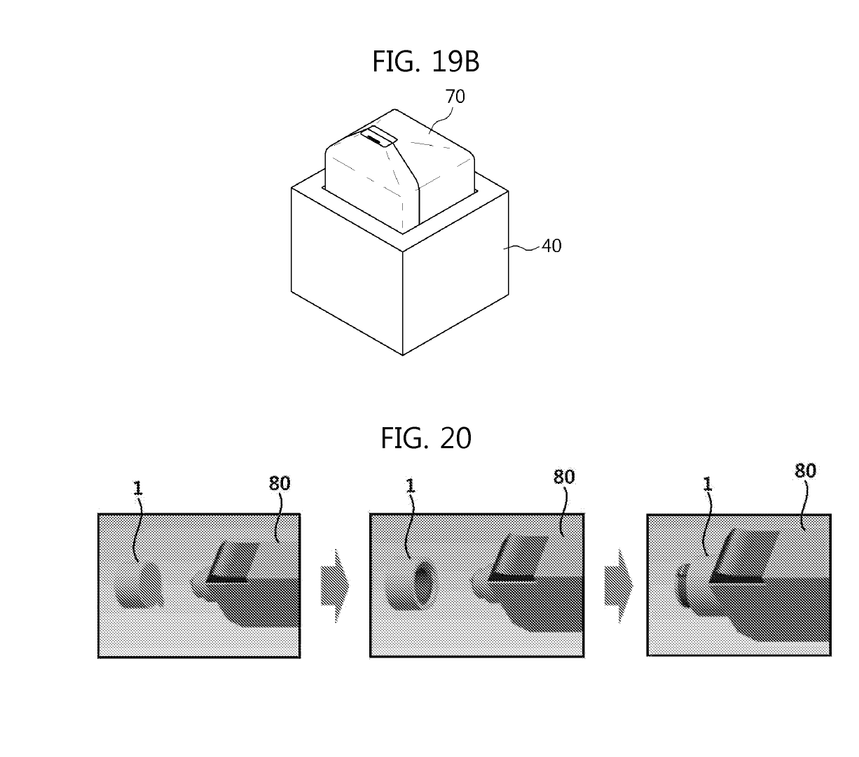

That is, as illustrated in FIG. 19A, when the main structure body 70 is received in the housing 40, and thus only the blocked base side 24 and an end of the second outer diameter portion 22 are exposed to the outside, at least one lower catching protrusion 44 is formed at the inner surface of the second inner diameter portion 42 in order to prevent the main structure body 70 from separating toward an end of the second inner diameter portion 42 of the housing 40.

Further, as illustrated in FIG. 19B, when the main structure body 70 protrudes to the outside of the housing 40, at least one upper catching protrusion 45 is formed at the second inner diameter portion 42 in order to maintain the state in which the main structure body 70 protrudes to the outside of the housing 40.

Further, the module type biosensor 1 may further include an upper cover 50 and a lower cover 60 which are attached to one end and the other end of the housing 40 and protects the reaction substrate 10 exposed to the outside through the main structure body 70. Further, a handle may be provided at the upper cover 50 and the lower cover 60 in order to easily remove the upper cover 50 and the lower cover 60.

Further, the main structure body 70 and the housing 40 may be formed of a synthetic resin such as plastic. Further, since they may be manufacture by injection molding, it is possible to easily change the shapes thereof.

Although a few embodiments of the present invention have been shown and described, it would be appreciated by those skilled in the art that changes may be made in these embodiments without departing from the principles and spirit of the invention, the scope of which is defined in the claims and their equivalents.

[Brief Description of Main Element]

| | |
|---|---|
| 1: module type biosensor | 10: reaction substrate |
| 11a: working electrode | 11b: operation signal transferring |
| | electrode |
| 12a: reference electrode | 12b: reference signal transferring |
| | electrode |
| 20: lower structure body | 21: first outer diameter portion |
| 22: second outer diameter portion | 23: first stepped surface |
| 24: blocked base side | 25: first coupling groove |
| 26: first coupling hole | 27: second coupling hole |
| 28: inner side wall | 30: upper structure body |
| 31: 1-1^{st} coupling groove | 32: coupling protrusion |
| 33: vent hole | 34: capillary groove |
| 35: introduction port | 40: housing |
| 41: first inner diameter portion | 42: second inner diameter portion |
| 43: second stepped surface | 44: lower catching protrusion |
| 45: upper catching protrusion | 50: upper cover |
| 60: lower cover | 70: main structure body |
| 71: first structure body | 72: second structure body |
| 80: detector | |

1. A module type biosensor comprising:
a reaction substrate which reacts with an introduced sample and generates a reaction signal;
a first structure body which is formed as a pole-shaped figure having an opening formed at one base side thereof and in which the reaction substrate is coupled to a blocked base side of a position corresponding to an opened base side having the opening formed thereat; and
a second structure body which is coupled to the blocked base side and forms a reaction chamber generating the reaction signal when being coupled to the blocked base side.

2. The module type biosensor of claim 1, further comprising a housing which is formed to enclose outer surfaces of the first structure body and the second structure body and slides along the outer surfaces of the first structure body and the second structure body.

3. The module type biosensor of claim 2, wherein the reaction substrate comprises a working electrode and a reference electrode which are formed at one surface thereof, and an operation signal transferring electrode and a reference signal transferring electrode which are formed at the same surface to which the working electrode and the reference electrode are formed or another surface so as to be electrically connected with the working electrode and the reference electrode, respectively.

4. The module type biosensor of claim 3, wherein the reaction substrate comprises a chemical substance which is fixed to upper portions of the working electrode and the reference electrode so as to react with the introduced sample.

5. The module type biosensor of claim 2, wherein a first coupling area to which the reaction substrate is coupled and a first coupling means to which the second structure body is coupled are formed at the blocked base side of the first structure body, and an opening which allows the reaction substrate to be in contact with the detector is formed at a predetermined area of the first coupling area.

6. The module type biosensor of claim 5, wherein the first coupling area is a coupling groove.

7. The module type biosensor of claim 6, wherein the coupling groove comprises a sample introduction passage which quickly transports the introduced sample to the reaction substrate.

8. The module type biosensor of claim 5, wherein the second structure body has a flat plate shape, and a second coupling area which is formed at a position facing the first coupling area so as to be coupled with the reaction substrate and a second coupling means which is coupled with the first coupling means are formed at one surface of the flat plate.

9. The module type biosensor of claim 8, wherein the second coupling area is a coupling groove.

10. The module type biosensor of claim 9, wherein the second coupling area comprises an air discharging means which discharges air introduced into an area together with the sample.

11. The module type biosensor of claim 8, wherein the second structure body comprises a sample introduction passage which quickly transports the introduced sample to the reaction substrate.

12. The module type biosensor of claim 1, wherein the housing has a hollow shape, and comprises at least one supporting means which is provided at an inner surface of the hollow shape so as to prevent separation of the first structure body.

13. The module type biosensor of claim 8, wherein the supporting means further comprises a first supporting means which prevents separation of the first structure body received in the housing; and a second supporting means which maintains a protruding state of the first structure body when the first structure body protrudes to an outside of the housing.

14. The module type biosensor of claim 2, wherein the first structure body further comprises a receiving space in which a dehumidifying agent is received.

15. The module type biosensor of claim 2, further comprising a first cover which is attached to one end of the housing and protects the reaction substrate exposed to an outside through the second structure body; and a second cover which is attached to the other end of the housing and protects the reaction substrate exposed to the outside through the first structure body.

16. A module type biosensor comprising:
a reaction substrate which reacts with an introduced sample and generates a reaction signal; and
a structure body in which an opening is formed at a hollow-shaped first base side thereof, and a second base side has a cap shape, and the reaction substrate is coupled to an inner surface of the second base side,
wherein the structure body comprises a coupling groove to which the reaction substrate is coupled, an introduction port through which a sample is introduced to the reaction substrate coupled to the coupling groove, and a capillary groove which quickly transports the sample introduced through the introduction port to the reaction substrate.

17. The module type biosensor of claim 16, further comprising a housing which is formed to enclose an outer surface of the structure body and slides along the outer surface of the structure body.

18. The module type biosensor of claim 17, wherein the structure body comprises an air discharging means which discharges air when the sample is introduced.

19. The module type biosensor of claim 17, wherein the housing has a hollow shape, and comprises at least one catching protrusion which is formed at an inner surface of the hollow shape so as to prevent separation of the structure body.

20. The module type biosensor of claim 19, wherein the catching protrusion further comprises a lower catching protrusion which prevents separation of the structure body received in the housing; and an upper catching protrusion which maintains a protruding state of the structure body when the structure body protrudes to an outside of the housing.

21. The module type biosensor of claim 17, wherein the structure body comprises a receiving space in which a dehumidifying agent is received.

22. The module type biosensor of claim 17, further comprising an upper cover which is attached to one end of the housing and protects the reaction substrate exposed to an outside through the structure body; and a lower cover which is attached to the other end of the housing and protects the reaction substrate exposed to the outside through the structure body.

23. A module type biosensor comprising:
a reaction substrate which reacts with an introduced sample and generates a reaction signal; and
a first structure body which has a hollow shape and in which a first outer diameter portion and a second outer diameter portion having a larger width than the first outer diameter portion are formed at an outer surface of the hollow shape to be adjacent to each other up and down, and a stepped surface is formed at a boundary portion between the first outer diameter portion and the second outer diameter portion, and a blocked base side is formed to extend toward an inner side of an end of the first outer diameter portion, and a coupling groove to which the reaction substrate is coupled is formed at an inner surface of the first outer diameter portion, and an introduction port through which a sample is introduced to the reaction substrate coupled to the coupling groove is formed at the blocked base side, and a capillary groove which quickly transports the sample introduced through the introduction port to the reaction substrate is formed at the coupling groove.

24. The module type biosensor of claim 23, further comprising a housing which is formed to enclose an outer surface of the first structure body and slides along the outer surface of the first structure body.

25. The module type biosensor of claim 1, wherein the first structure body comprises a second structure body which has the coupling groove and is coupled with the reaction substrate; and a third structure body which is coupled with the second structure body while the reaction substrate is interposed therebetween and forms the first structure body.

26. The module type biosensor of claim 25, wherein the second structure body comprises a capillary groove which comprises a reaction chamber at an area coupled with the reaction substrate.

27. The module type biosensor of claim 25, wherein the third structure body comprises a capillary groove which comprises a reaction chamber at an area coupled with the reaction substrate.

28. The module type biosensor of claim 24, further comprising an upper cover which is attached to one end of the housing and protects the reaction substrate exposed to an outside through the first structure body; and a lower cover which is attached to the other end of the housing and protects the reaction substrate exposed to the outside through the first structure body.
